(19) United States
(12) Patent Application Publication
(10) Pub. No.: US 2026/0133450 A1
(43) Pub. Date: May 14, 2026

(54) DISPLAY MODULE AND DISPLAY DEVICE

(71) Applicant: Guangzhou China Star Optoelectronics Semiconductor Display Technology Co., LTd., Guangzhou (CN)

(72) Inventor: Yanfeng LIU, Guangzhou (CN)

(73) Assignee: Guangzhou China Star Optoelectronics Semiconductor Display Technology Co., LTd., Guangzhou (CN)

(21) Appl. No.: 19/006,937

(22) Filed: Dec. 31, 2024

(30) Foreign Application Priority Data
Nov. 8, 2024 (CN) 202411598820.5

(51) Int. Cl. G02F 1/1333; G02F 1/1335; G02F 1/1362

(52) U.S. Cl. CPC G02F 1/133388; G02F 1/133308; G02F 1/133509; G02F 1/133528; G02F 1/1362

(57) ABSTRACT

A display module includes a backlight module, a display panel, and a decorative strip. The display panel is disposed in a frame of the backlight module and fixedly connected to the frame, and a height of the frame is lower than a height of the display panel; the display panel includes an array substrate, a color filter substrate, and a first polarizer, and the array substrate includes a first protrusion protruding from the color filter substrate; the decorative strip is disposed on the frame, and the decorative strip includes a first protective portion and a covering portion connected to each other, and a thickness of the covering portion is less than a thickness of the first protective portion; and a surface height of the first protective portion is lower than or equal to a surface height of the first polarizer.

### CROSS-REFERENCE TO RELATED APPLICATION

This application claims the priority to and benefit of Chinese Patent Application No. 202411598820.5, filed on Nov. 8, 2024, the disclosure of which is incorporated herein by reference in its entirety.

### TECHNICAL FIELD

The disclosure relates to the field of display, and in particular, to a display module and a display device.

### BACKGROUND

Liquid crystal display devices are widely used in various electronic products such as mobile phones, laptops, televisions, and vehicle-mounted display devices because of their advantages of high image quality, small size, and light weight. With the development of display technology, users have increasingly high requirements for the performance and appearance of the liquid crystal display devices. For example, in order to achieve the borderless design in visual, a liquid crystal display module is provided with a protective member to cover a part of an upper polarizer of the liquid crystal display module, and the front of the protective member is painted to replace the decorative strip (Deco) of the liquid crystal display device in related art, thereby reducing the thickness of the liquid crystal display device and achieving the borderless design in visual. However, this design causes obvious visual differences compared to the true borderless design.

### SUMMARY

Embodiments of the disclosure provide a display module, including:
a backlight module including a frame, in which the frame is provided with an accommodating cavity;
a display panel disposed on a light-emitting side of the backlight module and located in the accommodating cavity, in which the display panel is fixedly connected to the frame, and a height of the frame is lower than a height of the display panel in a thickness direction of the display module; the display panel includes an array substrate, a color filter substrate disposed opposite to the array substrate, and a first polarizer disposed on a side of the color filter substrate away from the array substrate; and the color filter substrate is disposed on a side of the array substrate away from the backlight module, the color filter substrate is concave relative to the array substrate, and the array substrate includes a first protrusion protruding from an edge of the color filter substrate; and
a decorative strip disposed on the frame, in which the decorative strip includes a first protective portion and a covering portion, the first protective portion is disposed on a side of the first protrusion away from the backlight module, and the covering portion is disposed on a side of the first protective portion away from the first protrusion;
in which a surface height of the first protective portion is lower than or equal to a surface height of the first polarizer in the thickness direction of the display module, and a thickness of the covering portion is less than a thickness of the first protective portion.

Embodiments of the disclosure further provide a display device including the display module as described above.

### BRIEF DESCRIPTION OF THE DRAWINGS

In order to explain technical solutions in embodiments of the disclosure more clearly, the following will briefly introduce the drawings needed to be used in description of the embodiments. Apparently, the drawings in the following description are only some embodiments of the disclosure. For ordinary skilled in the art, other drawings can be obtained from these drawings without paying creative effort.

FIG. 1 is a schematic cross-sectional structural diagram of a display module according to some embodiments of the disclosure.

FIG. 2 is another schematic cross-sectional structural diagram of a display module according to some embodiments of the disclosure.

FIG. 3 is another schematic cross-sectional structural diagram of a display module according to some embodiments of the disclosure.

FIG. 4 is another schematic cross-sectional structural diagram of a display module according to some embodiments of the disclosure.

### DETAILED DESCRIPTION

Specific embodiments that can be implemented in the disclosure are described in the following with reference to the attached drawings. In the disclosure, directional or positional relationships indicated by the terms “on”, “above”, “upper”, “below”, “lower”, “front”, “back”, “left”, “right”, “inside”, “outside”, “side”, “top”, and the like, are based on the directional or positional relationships shown in the drawings, which are used only for the convenience of describing the disclosure and simplifying the description. Therefore, the terms cannot be interpreted as a limitation on the disclosure. In the drawings, elements with similar structures are represented by the same numeral, and thicknesses of some layers have been exaggerated for clarity and ease of description. The size and the thickness of each element shown in the drawings are arbitrary, but the disclosure is not limited to this.

In view of the problem of obvious visual differences in the borderless design in visual, the inventor of the disclosure found that the main reason for the obvious visual differences is in that, after the protective member of the liquid crystal display module replaces the decorative strip, since the protective member is located above the upper polarizer, there is a large height difference between the protective member and the upper polarizer, resulting in obvious visual differences. As illustrated in FIG. 1, some embodiments of the disclosure provide a display module 20′ that includes a backlight module 10′ and a display panel 20′, and the display panel 20′ is disposed on a light-emitting side of the backlight module 10′. The display panel 20′ includes an array substrate 21′, a color filter substrate 22', and a first polarizer 23′ (an upper polarizer). The array substrate 21′ and the color filter substrate 22′ are disposed opposite to each other. The first polarizer 23′ is disposed on a side of the color filter substrate 22′ away from the array substrate 21′. The display module further includes a protective member 30′ disposed on the backlight module 10′, and the protective member 30′ is disposed above a part of the first polarizer 23′. The protective member 30′ can replace the decorative strip, reducing a thickness of the display panel 20′, and achieving the borderless design in visual. However, since the protective member 30′ is disposed above the first polarizer 23′, which may lead to a height difference between the protective member 30′ and the first polarizer 23′, resulting in obvious visual differences.

In order to solve the problem, the embodiments of the disclosure further provide a display module and a display device.

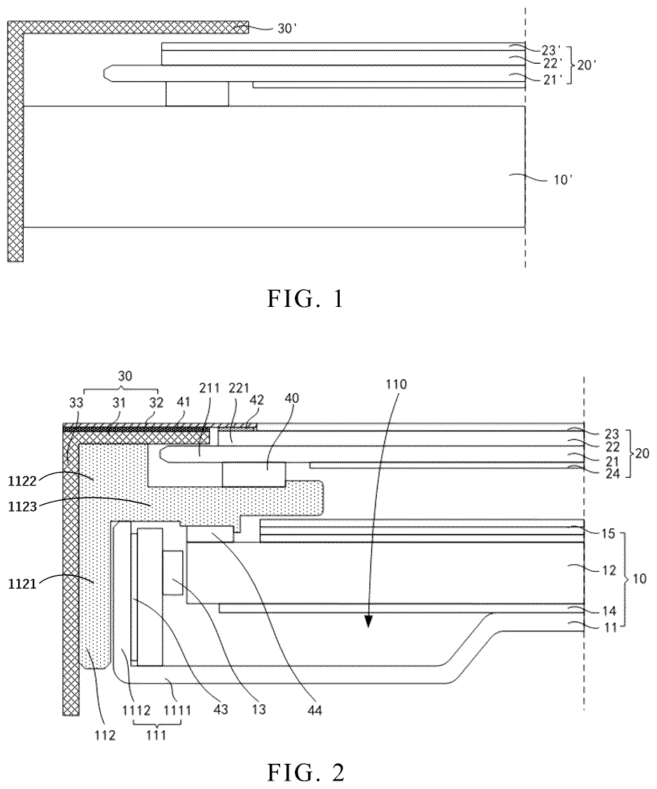

Referring to FIG. 2, FIG. 2 is a schematic cross-sectional structural diagram of a display module provided by some embodiments of the disclosure. Some embodiments of the disclosure provide a display module 100, which includes a backlight module 10, a display panel 20, and a decorative strip 30. The backlight module 10 includes a frame 11, and the frame 11 is provided with an accommodating cavity 110. A height of the frame 11 is lower than a height of the display panel 20 in a thickness direction of the display module 100. The display panel 20 is disposed on a light-emitting side of the backlight module 10 and located above the accommodating cavity 110. The display panel 20 is fixedly connected to the frame 11, for example, the display panel 20 is fixedly connected to the frame 11 through a first adhesive layer 40. In some embodiments, the display panel 20 is a liquid crystal display panel, and the display panel 20 includes an array substrate 21, a color filter substrate 22, and a first polarizer 23. The array substrate 21 and the color filter substrate 22 are disposed opposite to each other, and the first polarizer 23 is disposed on a side of the color filter substrate 22 away from the array substrate 21.

The display panel 20 further includes a liquid crystal layer, a sealant, and a second polarizer 24. The liquid crystal layer and the sealant are disposed between the array substrate 21 and the color filter substrate 22, and the second polarizer 24 is disposed on a side of the array substrate 21 away from the color filter substrate 22. The sealant surrounds the liquid crystal layer to seal the liquid crystal layer.

The color filter substrate 22 is disposed on a side of the array substrate 21 away from the backlight module 10, and the color filter substrate 22 is concave relative to the array substrate 21. The array substrate 21 includes a first protrusion 211 protruding from an edge of the color filter substrate 22. The first protrusion 211 is a part of the array substrate 21 exceeding a boundary of the color filter substrate 22. That is, an outer contour of the color filter substrate 22 is located in an outer contour of the array substrate 21, and an area of the outer contour of the color filter substrate 22 is less than an area of the outer contour of the array substrate 21. In other words, the first protrusion 211 is a part of the array substrate 21 that is not covered by the color filter substrate 22. The first protrusion 211 is configured to provide peripheral circuits, for example, the first protrusion 211 is provided with a binding circuit for binding a circuit board.

The display module 100 includes a display area and a border area disposed at a side of the display area, and the first protrusion 211 is disposed in the border area. The array substrate 21 includes a plurality of sub-pixels arranged in an array and located in the display area. Each of the sub-pixels includes a pixel driving circuit and a first electrode, and the pixel driving circuit is electrically connected to the first electrode, so as to provide a driving signal to the first electrode. In some embodiments, the color filter substrate 22 includes a second electrode and a color filter layer, and an electric field generates between the second electrode and the first electrode, so as to drive the deflection of liquid crystal molecules of the liquid crystal layer, and control the transmission amount of backlight of the backlight module 10. The color filter layer includes a plurality of color filter blocks and a black matrix disposed between every adjacent two color filter blocks. The color filter blocks include a plurality of red filter blocks, a plurality of green filter blocks, and a plurality of blue filter blocks, and each of the color filter blocks corresponds to one of the sub-pixels. It can be understood that the structures of the array substrate 21 and the color filter substrate 22 in the embodiments of the disclosure are illustrated for the purpose of description, and the disclosure is not limited thereto, for example, the second electrode can be disposed in the array substrate 21, and thus the color filter substrate 22 does not include the second electrode. For example, in some embodiments, both of the second electrode and the color filter layer are disposed in the array substrate 21.

The decorative strip 30 is disposed on the frame 11 and located in the border area. The decorative strip 30 includes a first protective portion 31 and a covering portion 32, the first protective portion 31 is disposed on a side of the first protrusion 211 away from the backlight module 10, and the covering portion 32 is disposed on a side of the first protective portion 31 away from the first protrusion 211. In some embodiments, the covering portion 32 is connected to the first protective portion 31 through a second adhesive layer 41. The decorative strip 30 is configured to protect the binding circuit disposed on the first protrusion 211 and protect the circuit board bound to the binding circuit. In order to better protect the circuit board and other components bound to the binding circuit, in some embodiments, the decorative strip 30 further covers a second protective portion 33 connected to the first protective portion 31, and the second protective portion 33 extends in the thickness direction of the display module 100.

A surface height of the first protective portion 31 is lower than or equal to a surface height of the first polarizer 23 in the thickness direction of the display module 100, so that the covering portion 32 cooperates with the first protective portion 31 to reduce or eliminate the height difference between the first protective portion 31 and the first polarizer 23, so as to reduce visual differences and make it visually closer to the true borderless effect, thereby improving the problem of obvious visual differences in the borderless design in visual.

In the disclosure, “surface height” of an element refers to a maximum vertical height of the element relative to a reference plane, that is, “surface height” of the element refers to a vertical distance between a top surface of the element and the reference plane. For example, the surface height of the first protective portion 31 refers to a maximum vertical height of the first protective portion 31 relative to the array substrate 21, that is, the surface height of the first protective portion 31 refers to a vertical distance between a top surface of the first protective portion 31 and a top surface of the array substrate 21. In the disclosure, the top surface of the first protective portion 31 refers to a surface of the first protective portion 31 away from the first protrusion 211, and the top surface of the array substrate 21 refers to a surface of the array substrate 21 close to the first protective portion 31.

Moreover, the surface height of the first polarizer 23 refers to a maximum vertical height of the first polarizer 23 relative to the array substrate 21, that is, the surface height of the first polarizer 23 refers to a vertical distance between a top surface of the first polarizer 23 and the top surface of the array substrate 21. In the disclosure, the top surface of the first polarizer 23 refers to a surface of the first polarizer 23 away from the color filter substrate 22.

Therefore, the surface height of the first protective portion 31 is lower than or equal to the surface height of the first polarizer 23 in the thickness direction of the display module 100, that is, the vertical distance between the top surface of the first protective portion 31 and the top surface of the array substrate 21 is less than or equal to the vertical distance between the top surface of the first polarizer 23 and the top surface of the array substrate 21 in the thickness direction of the display module 100. In other words, the top surface of the first protective portion 31 is flush with the top surface of the first polarizer 23, or, the top surface of the first protective portion 31 is lower than the top surface of the first polarizer 23, so as to reduce or eliminate the height difference between the first protective portion 31 and the first polarizer 23. Moreover, the covering portion 32 is connected to the first protective portion 31, and therefore the first protective portion 31 cooperates with the covering portion 32 to facilitate the adjustment of the height difference between the first protective portion 31 and the first polarizer 23.

A thickness of the covering portion 32 is less than a thickness of the first protective portion 31, so as to better adjust the height difference between the first protective portion 31 and the first polarizer 23. In the disclosure, “thickness” of an element refers to the thickness of the element in the thickness direction of the display module 100. For example, the thickness of the covering portion 32 refers to the thickness of the covering portion 32 in the thickness direction of the display module 100, and the thickness of the first protective portion 31 refers to the thickness of the first protective portion 31 in the thickness direction of the display module 100.

In some embodiments, the covering portion 32 on the first protective portion 31 extends to the color filter substrate 22. The first polarizer 23 is concave relative to the color filter substrate 22, the color filter substrate 22 includes a second protrusion 221 protruding from an edge of the first polarizer 23, and the covering portion 32 is connected to the second protrusion 221. For example, the covering portion 32 is connected to the second protrusion 221 through a third adhesive layer 42. In the disclosure, materials of the third adhesive layer 42 and the second adhesive layer 41 can be selected from different or the same type of adhesive materials according to materials of the structures being bound. Moreover, definition of the second protrusion 221 can refer to the definition of the first protrusion 211, and is not repeated herein.

In some embodiments, the covering portion 32 is abutted with the first polarizer 23, so that a top surface of the display module 100 is continuous, which can further reduce the visual differences. In some embodiments, in order to reduce the difficulty of disposing the covering portion 32, a gap presents between the covering portion 32 and the first polarizer 23. In some embodiments, a surface height of the covering portion 32 is equal to the surface height of the first polarizer 23 in the thickness direction of the display module 100, that is, a top surface of the covering portion 32 is flush with the top surface of the first polarizer 23, which further reduces the visual differences, and makes it visually closer to the true borderless effect. Definition of the surface height of the covering portion 32 can refer to the definition of the surface height of the first protective portion 31, and is not repeated herein.

The structure of the display module 100 will be described in detail below.

As illustrated in FIG. 2, the backlight module 10 further includes a light guide plate 12 and a light source 13, and the frame 11 is provided with the accommodating cavity 110 for accommodating and protecting the light guide plate 12 and the light source 13. The light guide plate 12 and the light source 13 are disposed in the accommodating cavity 110, and the light guide plate 12 and the light source 13 are fixedly connected to the frame 11. The light source 13 is disposed facing at least one side surface of the light guide plate 12. The side surface of the light guide plate 12 is connected between an upper surface and a lower surface of the light guide plate 12, and the lower surface of the light guide plate 12 is provided opposite to the upper surface of the light guide plate 12. The upper surface of the light guide plate 12 is a light-emitting surface of the light guide plate 12, and the side surface of the light guide plate 12 facing the light source 13 is a light-entering surface of the light guide plate 12.

The backlight module 10 further includes other optical film sheets such as a reflective sheet 14 and a brightness enhancement film 15. The reflective sheet 14 is disposed on the lower surface of the light guide plate 12, and the brightness enhancement film 15 is disposed on the upper surface of the light guide plate 12. The reflective sheet 14 is configured to reflect light leaking from the lower surface of the light guide plate 12, so as to improve the utilization rate of light. The brightness enhancement film 15 is configured to increase the brightness of light emitted from the light guide plate 12.

In some embodiments, the frame 11 includes a back plate 111 and an adhesive frame 112. The back plate 111 includes a bottom plate 1111 and a side plate 1112 surrounding the bottom plate 1111. For example, the back plate 111 is a metal back plate, such as an aluminum back plate. The bottom plate 1111 is provided with a recessed portion corresponding to the light source 13, and the recessed portion is configured to provide an avoidance space for assembling the light source 13, so as to improve the overall strength of the back plate 111. The light source 13 is fixed to an inner side wall of the side plate 1112, for example, the light source 13 is fixedly connected to the inner side wall of the side plate 1112 through the fourth adhesive layer 43. In the disclosure, the inner side wall of the side plate 1112 refers to an inner wall of the accommodating cavity 110.

The adhesive frame 112 is fixed on the side plate 1112, and the adhesive frame 112 is in a “T” shape. In some embodiments, as illustrated in FIG. 2, the adhesive frame 112 includes a first sub-portion 1121, a second sub-portion 1122, and a third sub-portion 1123. The first sub-portion 1121 and the second sub-portion 1122 are connected to each other, and the first sub-portion 1121 and the second sub-portion 1122 extend in the thickness direction of the display module 100. The third sub-portion 1123 is connected between the first sub-portion 1121 and the second sub-portion 1122, and an extension direction of the third sub-portion 1123 is different from the extension directions of the first sub-portion 1121 and the second sub-portion 1122, which are the same. Furthermore, the first sub-portion 1121 is disposed on an outer side wall of the side plate 1112, the third sub-portion 1123 is disposed on an end portion of the side plate 1112, and the second sub-portion 1122 is disposed on a side of the third sub-portion 1123 away from the first sub-portion 1121. The array substrate 21 is fixedly connected to a side of the third sub-portion 1123 through the first adhesive layer 40, and the light guide plate 12 is fixedly connected to another side of the third sub-portion 1123 through a fifth adhesive layer 44.

The first protective portion 31 is disposed on an end portion of the second sub-portion 1122, and the second protective portion 33 is disposed on a side of the adhesive frame 112 away from the accommodating cavity 110. Specifically, the second protective portion 33 is disposed on an outer side wall of the second sub-portion 1122, and the second protective portion 33 extends from the outer side wall of the second sub-portion 1122 to an outer side wall of the first sub-portion 1121. The first protective portion 31 is further disposed corresponding to the light source 13, and the second protective portion 33 cooperates with the first protective portion 31 to semi surround the adhesive frame 112. For example, the second protective portion 33 and the first protective portion 31 cover an upper surface and a side surface of the adhesive frame 112.

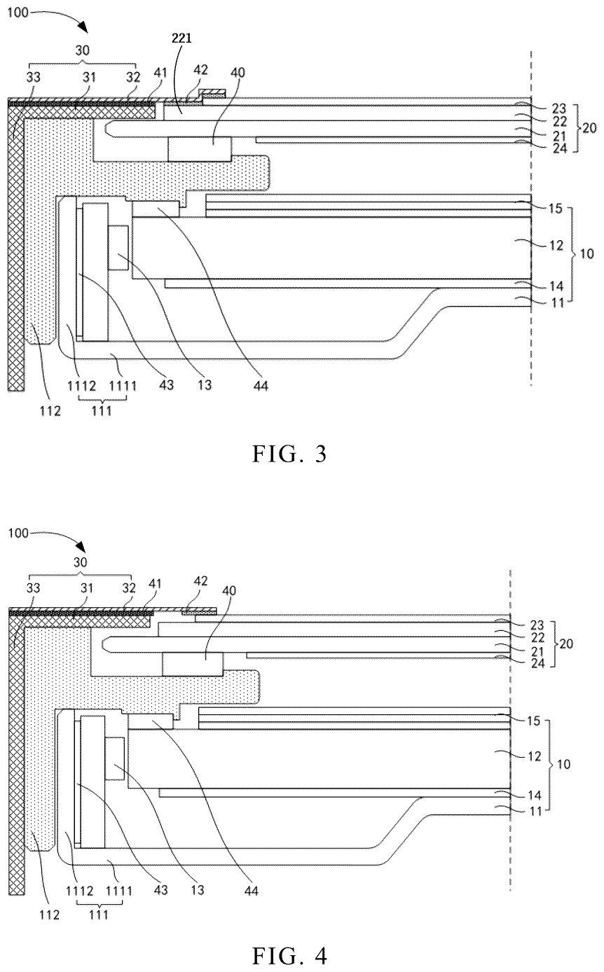

Referring to FIG. 3, FIG. 3 is another schematic cross-sectional structural diagram of the display module 100 provided by some embodiments of the disclosure. The display module 100 illustrated in FIG. 3 is different from the display module 100 illustrated in FIG. 2 in that the covering portion 32 on the second protrusion 221 extends to the first polarizer 23, and the covering portion 32 is connected to the first polarizer 23, so as to reduce the difficulty of disposing the covering portion 32 and improve the feasibility of the process. Other structures of the display module 100 illustrated in FIG. 3 can refer to the above-mentioned embodiments, and will not be repeated here.

Referring to FIG. 4, FIG. 4 is another schematic cross-sectional structural diagram of the display module 100 provided by some embodiments of the disclosure. The display module 100 illustrated in FIG. 4 is different from the display module 100 illustrated in FIG. 2 in that the covering portion 32 on the first protective portion 31 extends to the first polarizer 23, and the covering portion 32 is connected to the first polarizer 23. That is, the covering portion 32 is not connected to the color filter substrate 22, but is connected to the first polarizer 23, which can reduce the difficulty of disposing the covering portion 32. Other structures of the display module 100 illustrated in FIG. 4 can refer to the above-described embodiments, and will not be repeated here.

Based on the same inventive concept, some embodiments of the disclosure provide a display device including the display module 100 as described in any one of the above-mentioned embodiments. For example, the display device is a device including a display screen, such as a television, a mobile phone, a tablet, a computer monitor, a gaming device, a digital camera, a car navigator, an ATM, a wearable device, or the like.

The embodiments of the disclosure provide the display module and the display device including the display module. The display module includes the backlight module and the display panel disposed on the light-emitting side of the backlight module; the display panel is disposed in the frame of the backlight module and fixedly connected to the frame; the height of the frame is lower than the height of the display panel in the thickness direction of the display module; the display panel includes the array substrate, the color filter substrate, and the first polarizer arranged sequentially in the light-emitting direction of the backlight module; the array substrate includes the first protrusion protruding from the color filter substrate; the display module further includes a decorative strip disposed on the frame, and the decorative strip includes the first protective portion and the covering portion connected to each other, and the thickness of the covering portion is less than the thickness of the first protective portion; and the surface height of the first protective portion is lower than or equal to the surface height of the first polarizer. Therefore, the first protective portion cooperates with the covering portion to reduce or eliminate the height difference between the first protective portion and the first polarizer, thereby reducing visual differences and making it visually closer to the true borderless effect, and improving the problem of obvious visual differences in the borderless design in visual.

In the above-described embodiments, the description of each embodiment has its own emphasis. For parts not described in detail in a certain embodiment, please refer to the relevant descriptions of other embodiments.

The above provides a detailed description to the display module and the display device provided in the embodiments of the disclosure. Specific embodiments are applied in this context to explain the principles and implementation methods of the disclosure. The explanation of the above-mentioned embodiments is only used to help understand the technical solutions and core ideas of the disclosure. For ordinary skilled in the art, there may be changes in the specific implementation methods and scopes based on the ideas of the disclosure. Therefore, the contents of the disclosure should not be understood as limitations on the disclosure.

What is claimed is:

1. A display module comprising:
a backlight module comprising a frame, wherein the frame is provided with an accommodating cavity;
a display panel disposed on a light-emitting side of the backlight module and located in the accommodating cavity, wherein the display panel is fixedly connected to the frame, and a height of the frame is lower than a height of the display panel in a thickness direction of the display module; wherein the display panel comprises an array substrate, a color filter substrate disposed opposite to the array substrate, and a first polarizer disposed on a side of the color filter substrate away from the array substrate; and the color filter substrate is disposed on a side of the array substrate away from the backlight module, the color filter substrate is concave relative to the array substrate, and the array substrate comprises a first protrusion protruding from an edge of the color filter substrate; and
a decorative strip disposed on the frame, wherein the decorative strip comprises a first protective portion and a covering portion, the first protective portion is disposed on a side of the first protrusion away from the backlight module, and the covering portion is disposed on a side of the first protective portion away from the first protrusion;
wherein a surface height of the first protective portion is lower than or equal to a surface height of the first polarizer in the thickness direction of the display module, and a thickness of the covering portion is less than a thickness of the first protective portion.

2. The display module of claim 1, wherein the covering portion on the first protective portion extends to the color filter substrate, the first polarizer is concave relative to the color filter substrate, the color filter substrate comprises a second protrusion protruding from an edge of the first polarizer, and the covering portion is connected to the second protrusion.

3. The display module of claim 2, wherein the covering portion is abutted with the first polarizer, and a surface height of the covering portion is equal to the surface height of the first polarizer in the thickness direction of the display module.

4. The display module of claim 2, wherein the covering portion is abutted with the first polarizer, and a top surface of the covering portion is flush with a top surface of the first polarizer.

5. The display module of claim 2, wherein the covering portion on the second protrusion extends to the first polarizer, and the covering portion is connected to the first polarizer.

6. The display module of claim 1, wherein the covering portion on the first protective portion extends to the first polarizer, and the covering portion is connected to the first polarizer.

7. The display module of claim 1, wherein the thickness of the covering portion is less than a thickness of the first polarizer.

8. The display module of claim 1, wherein a material of the covering portion comprises at least one of aluminum, stainless steel, polycarbonate, and a glass.

9. The display module of claim 1, further comprising:
a light guide plate disposed in the accommodating cavity and facing the display panel; and
a light source disposed corresponding to a side surface of the light guide plate and the first protective portion.

10. The display module of claim 9, wherein the frame comprises a back plate and an adhesive frame, the back plate comprises a bottom plate and a side plate surrounding the bottom plate, and the adhesive frame is fixedly connected to the side plate; and
wherein the decorative strip further comprises a second protective portion connected to the first protective portion, the second protective portion is disposed on a side of the adhesive frame away from the accommodating cavity, and the second protective portion and the first protective portion partially surround the adhesive frame.

11. A display device comprising a display module, wherein the display module comprises:
a backlight module comprising a frame, wherein the frame is provided with an accommodating cavity;
a display panel disposed on a light-emitting side of the backlight module and located in the accommodating cavity, wherein the display panel is fixedly connected to the frame, and a height of the frame is lower than a height of the display panel in a thickness direction of the display module; wherein the display panel comprises an array substrate, a color filter substrate disposed opposite to the array substrate, and a first polarizer disposed on a side of the color filter substrate away from the array substrate; and the color filter substrate is disposed on a side of the array substrate away from the backlight module, the color filter substrate is concave relative to the array substrate, and the array substrate comprises a first protrusion protruding from an edge of the color filter substrate; and
a decorative strip disposed on the frame, wherein the decorative strip comprises a first protective portion and a covering portion, the first protective portion is disposed on a side of the first protrusion away from the backlight module, and the covering portion is disposed on a side of the first protective portion away from the first protrusion;
wherein a surface height of the first protective portion is lower than or equal to a surface height of the first polarizer in the thickness direction of the display module, and a thickness of the covering portion is less than a thickness of the first protective portion.

12. The display device of claim 11, wherein the covering portion on the first protective portion extends to a top surface of the color filter substrate, the first polarizer is concave relative to the color filter substrate, the color filter substrate comprises a second protrusion protruding from an edge of the first polarizer, and the covering portion is connected to the second protrusion.

13. The display device of claim 12, wherein the covering portion is abutted with the first polarizer, and a surface height of the covering portion is equal to the surface height of the first polarizer in the thickness direction of the display module.

14. The display device of claim 12, wherein the covering portion is abutted with the first polarizer, and a top surface of the covering portion is flush with a top surface of the first polarizer.

15. The display device of claim 12, wherein the covering portion on the second protrusion extends to a top surface of the first polarizer, and the covering portion is connected to the first polarizer.

16. The display device of claim 11, wherein the covering portion on the first protective portion extends to a top surface of the first polarizer, and the covering portion is connected to the first polarizer.

17. The display device of claim 11, wherein the thickness of the covering portion is less than a thickness of the first polarizer.

18. The display device of claim 11, wherein a material of the covering portion comprises at least one of aluminum, stainless steel, polycarbonate, and a glass.

19. The display device of claim 11, wherein the display module further comprises:
a light guide plate disposed in the accommodating cavity and facing the display panel; and
a light source disposed corresponding to a side surface of the light guide plate and the first protective portion.

20. The display device of claim 19, wherein the frame comprises a back plate and an adhesive frame, the back plate comprises a bottom plate and a side plate surrounding the bottom plate, and the adhesive frame is fixedly connected to the side plate; and
wherein the decorative strip further comprises a second protective portion connected to the first protective portion, the second protective portion is disposed on a side of the adhesive frame away from the accommodating cavity, and the second protective portion and the first protective portion partially surround the adhesive frame.
